(19) United States
(12) Patent Application Publication
(10) Pub. No.: US 2025/0320333 A1
(43) Pub. Date: Oct. 16, 2025

(54) COMPOSITION FOR PREPARING POLYCAPROLACTONE SHAPE MEMORY MATERIAL, AND POLYCAPROLACTONE SHAPE MEMORY MATERIAL, PREPARATION METHOD THEREFOR, AND APPLICATION THEREOF

(71) Applicants: CHINA PETROLEUM & CHEMICAL CORPORATION, Beijing (CN); SINOPEC NANJING RESEARCH INSTITUTE OF CHEMICAL INDUSTRY CO., LTD., Nanjing, Jiangsu (CN)

(72) Inventors: Feng JIA, Nanjing, Jiangsu (CN); Chen CHEN, Nanjing, Jiangsu (CN); Lemeng SHI, Nanjing, Jiangsu (CN); Ruomei GAO, Nanjing, Jiangsu (CN); Zhao WU, Nanjing, Jiangsu (CN); Weizhou YAO, Nanjing, Jiangsu (CN)

(21) Appl. No.: 18/704,364

(22) PCT Filed: Oct. 28, 2022
(86) PCT No.: PCT/CN2022/128226

§ 371 Date: Apr. 24, 2024

(30) Foreign Application Priority Data
Oct. 28, 2021 (CN) 202111266177.2

(51) Int. Cl. C08G 63/91; C08G 63/82; C08G 63/83; C08G 63/85; C08G 83/00; C08J 3/24

(52) U.S. Cl. CPC C08G 63/912; C08G 63/823; C08G 63/83; C08G 63/85; C08G 83/007; C08J 3/247; C08J 2367/04

(57) ABSTRACT

A composition for preparing a polycaprolactone shape memory material, and a polycaprolactone shape memory material, a preparation method therefor, and a use thereof are provided. The material contains a plurality of modified polyrotaxane macromolecular chains, and a plurality of composite macromolecular chains connected to different modified polyrotaxane macromolecular chains, wherein each of the composite macromolecular chains comprises at least two segments of polycaprolactone macromolecular chains, a reversible linking group between different polycaprolactone macromolecular chains, and a linking modification group for linking cyclodextrin-derived cyclic structures comprised in the polycaprolactone macromolecular chains and the modified polyrotaxane macromolecular chains. The reversible linking group is a photo-reversible linking group or a thermally reversible linking group. The network topology defect of a polymer is adjusted to improve the toughness of the shape memory material to improves its designability and solid remoldability.

### CROSS-REFERENCE TO RELATED APPLICATIONS

The present disclosure claims the benefit of Chinese patent application “202111266177.2”, filed on Oct. 28, 2021, the content of which is specifically and entirely incorporated herein by reference.

### FIELD

The present disclosure relates to the field of polycaprolactone shape memory materials, in particular to a composition for preparing a polycaprolactone shape memory material, and a polycaprolactone shape memory material, a preparation method therefor, and a use thereof.

### BACKGROUND

The shape memory material is a kind of material that can be endowed a certain shape (initial state) under certain conditions, and when the external conditions change, for example, after applying certain stimuli such as heat, illumination, energization, chemical treatment, it can change its shape accordingly and fix the shape (temporary shape), and if the external environment further changes according to a specific way and pattern, the material can reversibly return to the initial state. The shape memory polymer materials (SMPs), as one of the shape memory materials, have advantages such as desirable shape change (recoverable deformation up to 1000%), low density, low cost, structural designability, and controllability of deformation recovery behavior compared with other shape memory materials (alloys, ceramics), it has widespread applications in the biomedicine, aerospace industry, automobile, and robot industry and the other field.

Generally speaking, in order to prevent the memory property degradation caused by slippage of the polymer molecular chains in the shape memory cycle, it is necessary to crosslink the polymer molecular chains to fix their permanent shape, but the mixing of the polymer network precursors, the connection of the ends, or an occurrence of the chain growth reaction will continuously carry out until the formation of the polymer network, which is a statistical process, so that most of the polymer networks have defects, thereby limiting the properties of the material. For example, uneven distribution of network nods may result in the uneven stress distribution of the material during the stress-strain cycles, and both the shape recovery performance and toughness do not meet the predetermined requirements. In addition, the cross-linked network of the conventional polymer is generally irreversible covalent bonding, once the shape memory material is formed, the permanent shape of the shape memory material cannot be altered and cannot be further processed and formed, thereby limiting the application ranges of the shape memory material in various fields. Due to excellent biodegradability and biocompatibility, the polycaprolactone shape memory material is often used as a biomedical material, but because of its uneven cross-linked network and the non-reworkability, the shape recovery rate of the material is low, and the error-tolerance rate is low when the material is used for disposable medical supplies.

Therefore, it is necessary to develop an improved preparation method for the polycaprolactone shape memory material.

### SUMMARY

The present disclosure aims to overcome the defects of the polycaprolactam shape memory material in the toughness, complex shape designability, and solid remoldability in the prior art, and provides a composition for preparing a polycaprolactone shape memory material, and a polycaprolactone shape memory material, a preparation method therefor, and a use thereof.

In order to achieve the above object, the first aspect of the present disclosure provides a polycaprolactone shape memory material comprising a plurality of modified polyrotaxane macromolecular chains, and a plurality of composite macromolecular chains connected to different modified polyrotaxane macromolecular chains, wherein each of the composite macromolecular chains comprises at least two segments of polycaprolactone macromolecular chains, a reversible linking group between different polycaprolactone macromolecular chains, and a linking modification group for linking cyclodextrin-derived cyclic structures comprised in the polycaprolactone macromolecular chains and the modified polyrotaxane macromolecular chains, wherein the reversible linking group is a photo-reversible linking group or a thermally reversible linking group.

The second aspect of the present disclosure provides a composition for preparing the polycaprolactone shape memory material of the present disclosure, wherein the composition comprises a polyrotaxane initiator, an end group modifier, ϵ-caprolactone, a catalyst, and a cross-linking agent; wherein the end group modifier is selected from nitrocinnamate compounds and/or 4-((4-methyl-2-oxo-2H-chromene-7-yl) oxy) butyric acid.

The third aspect of the present disclosure provides a method for preparing a polycaprolactone shape memory material comprising the following steps:
(1) subjecting the polyrotaxane to hydroxypropylation to obtain hydroxypropylated polyrotaxane;
(2) carrying out a ring-opening polymerization on the hydroxypropylated polyrotaxane and ϵ-caprolactone in the presence of a catalyst, to obtain a polycaprolactone grafted polyrotaxane copolymer;
(3) subjecting the polycaprolactone grafted polyrotaxane copolymer and photo-reversible groups of an end group modifier to a modification reaction to obtain a polymer network precursor, wherein the end group part of the polymer network precursor is modified into the photo-reversible group;
(4) promoting the reaction of the photo-reversible group to cross-link the polymer network precursor in the presence of a cross-linking agent and the action of heating and ultraviolet light, to prepare the polycaprolactone shape memory material.

The fourth aspect of the present disclosure provides a polycaprolactone shape memory material prepared with the method of the present disclosure.

The fifth aspect of the present disclosure provides a use of the polycaprolactone shape memory material of the present disclosure in a medical recoverable fixation material.

Due to the technical scheme, the present disclosure prepares the polycaprolactone shape memory material by modifying polyrotaxane and using the modified polyrotaxane as an initiator, and obtaining a polycaprolactone (PCL) having slidable macromolecular chains through a ring-opening polymerization, then modifying the end group moiety of the PCL into photo-reversible groups and cross-linking the groups to form a cross-linked structure. By designing the cross-linked network of the polycaprolactone shape memory material with a slidable structure, the network topology defect of a polymer is adjusted to improve the toughness of the shape memory material. The cross-linking mode is modified into a reversible bonding, the introduced dynamic covalent bond can realize the complex shape designability and solid remoldability of the shape memory material.

### BRIEF DESCRIPTION OF THE DRAWINGS

FIG. 1 illustrates a nuclear magnetic comparison diagram of polyethylene glycol diamine and α-cyclodextrin, and the polyrotaxane prepared in Example 1; wherein FIG. 1(a) shows a structural schematic view and the ¹H-NMR spectrogram of α-cyclodextrin, FIG. 1(b) shows a structural schematic view and the ¹H-NMR spectrogram of polyethylene glycol diamine, and FIG. 1(c) shows a structural schematic view and the ¹H-NMR spectrogram of polyrotaxane prepared in Example 1;

FIG. 2 illustrates a GPC (gel permeation chromatography) comparison diagram of polyethylene glycol diamine and α-cyclodextrin, and the polyrotaxane prepared in Example 1;

FIG. 3 is the ¹H-NMR spectrogram of hydroxypropylated polyrotaxane prepared in Example 1;

FIG. 4 illustrates an infrared comparison diagram of polyrotaxane, hydroxypropylated polyrotaxane, and polycaprolactone grafted polyrotaxane copolymers prepared in Example 1;

FIG. 5 is the ¹H-NMR spectrogram of the polycaprolactone grafted polyrotaxane copolymer prepared in Example 1;

FIG. 6 is a schematic diagram showing a network with a cross-linked structure of the polycaprolactone shape memory material;

FIG. 7 is a demonstration diagram showing the shape remodeling process of the polycaprolactone shape memory material provided by the present disclosure.

### DESCRIPTION

The end groups and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point value of the various ranges, and the individual point values may be combined with one another to produce one or more new numerical ranges, which should be deemed have been specifically disclosed herein.

The first aspect of the present disclosure provides a polycaprolactone shape memory material comprising a plurality of modified polyrotaxane macromolecular chains, and a plurality of composite macromolecular chains connected to different modified polyrotaxane macromolecular chains, wherein each of the composite macromolecular chains comprises at least two segments of polycaprolactone macromolecular chains, a reversible linking group between different polycaprolactone macromolecular chains, and a linking modification group for linking cyclodextrin-derived cyclic structures comprised in the polycaprolactone macromolecular chains and the modified polyrotaxane macromolecular chains, wherein the reversible linking group is a photo-reversible linking group or a thermally reversible linking group.

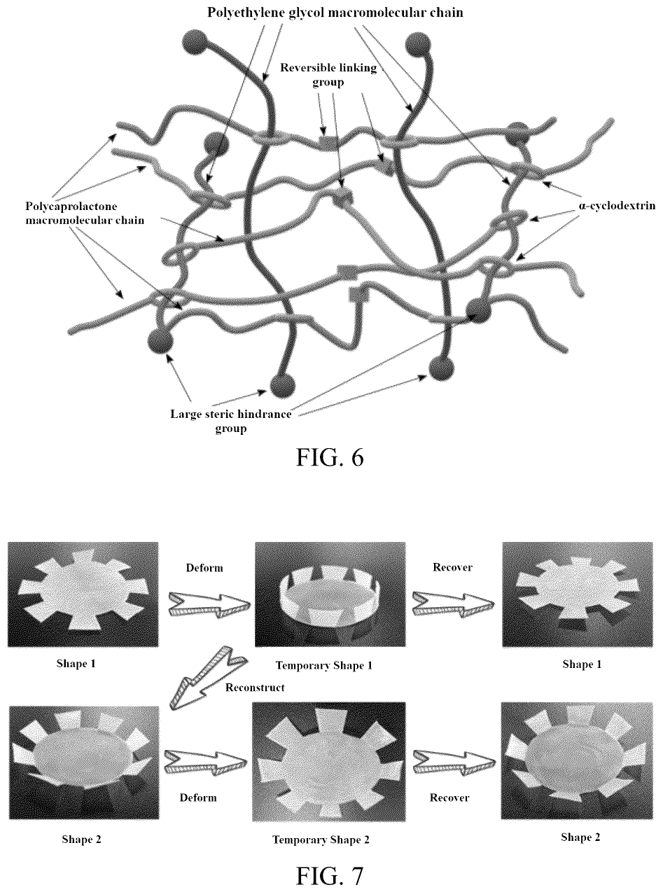

The structure of the polycaprolactone shape memory material provided by the present disclosure can be illustrated in FIG. 6.

In some embodiments of the present disclosure, the photo-reversible linking group is preferably derived from a compound having a photo-reversible group, more preferably, the compound is selected from nitrocinnamate compounds and/or 4-((4-methyl-2-oxo-2H-chromene-7-yl)oxy)butyric acid. The nitrocinnamate compound may be a compound represented by the following formula:

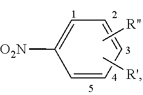

wherein the group R′ is a substituent substituted on at least one position indicated by the numerals 1-5 of the benzene ring, and R′ has a structure represented by the following formula

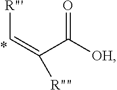

wherein R″″ and R′″ are each independently selected from H or a linear or branched C₁-C₆ alkyl, * represents a bonding point with the benzene ring; R″ is a substituent substituted on at least one position indicated by the numerals 1-5 of the benzene ring other than the position substituted by the group R′, R″ is H or a linear or branched C₁-C₆ alkyl, preferably, the nitrocinnamate compound is a compound represented by the following formula:

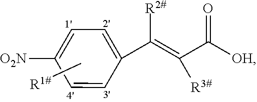

wherein R^{1 #}, R^{2 #} and R^{3 #} each are respectively and independently selected from H or a linear or branched C₁-C₆ alkyl, the substitution position of R^{1 #} is at least one position indicated by the numerals 1′-4′ of the benzene ring, and most preferably 4-nitrocinnamate (wherein R^{1 #}, R^{2 #} and R^{3 #} are H).

Taking 4-nitrocinnamate as an example, the formed photo-reversible linking group may have the following schematic structure:

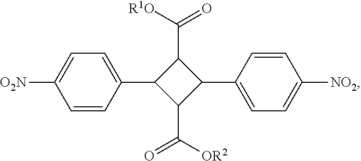

the process of forming the photo-reversible linking group may be illustrated as follows:

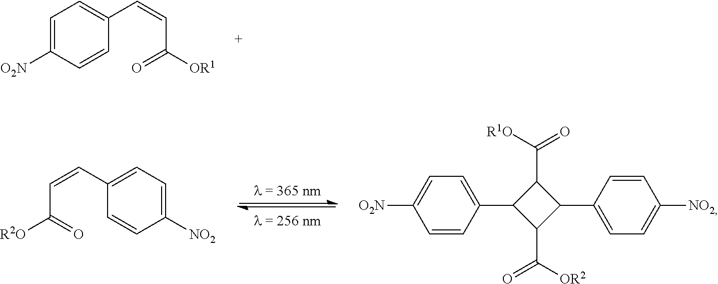

wherein R¹ and R² denote the different polycaprolactone macromolecular chains attached with the different modified polyrotaxanes.

In some embodiments of the present disclosure, the thermally reversible linking group is preferably derived from diisocyanate, and the diisocyanate is preferably at least one selected from the group consisting of hexamethylene diisocyanate, toluene diisocyanate, isophorone diisocyanate, and lysine diisocyanate. The formed reversible linking group may have the following schematic structure:

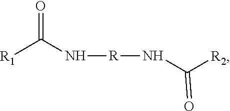

taking hexamethylene diisocyanate as an example, the thermally reversible process formed in the present disclosure may be illustrated as follows:

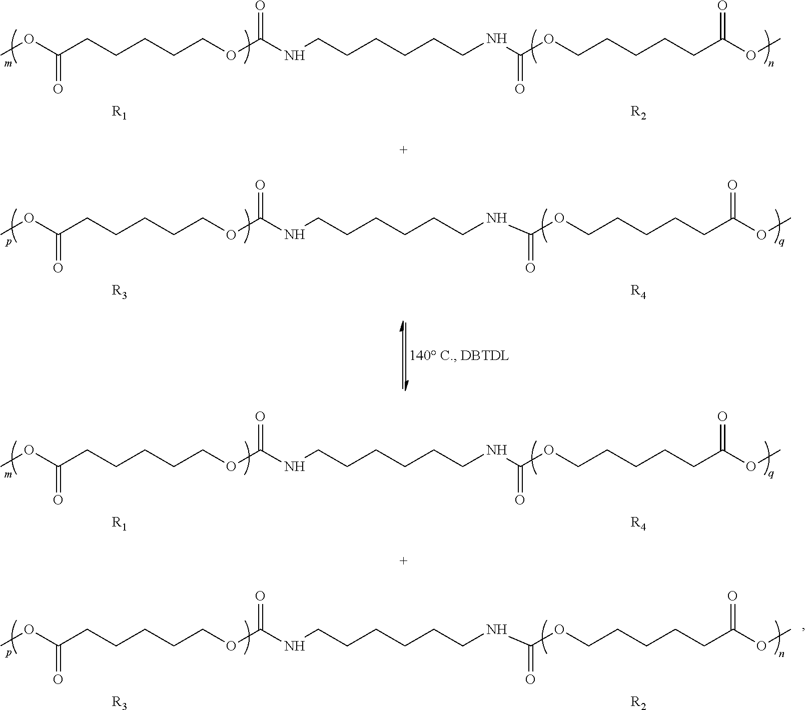

wherein R₁, R₂, R₃, and R₄ denote the different polycaprolactone macromolecular chains attached with different modified polyrotaxanes, and R represents the main group of diisocyanate (the structure excluding two isocyanate groups).

In some embodiments of the present disclosure, the linking modification group is preferably derived from a compound for hydroxypropylation. For example, the group may have the polypeptide macromolecular chain structure which is formed based on the modified group formed through the hydroxypropylation between the cyclodextrin-derived cyclic structures comprised in the polycaprolactone macromolecular chains and the epoxypropane, and then initiating ring-opening polymerization. The group is preferably a group represented by the structural formula —CH₂—CH(CH₃)—O—.

In some embodiments of the present disclosure, the total amount of the polycaprolactone molecular chains is preferably from 80 wt % to 100 wt %, more preferably from 95 wt % to 99.9 wt %, based on the total amount of the modified polyrotaxane macromolecular chains.

In some embodiments of the present disclosure, the polycaprolactone macromolecular chains preferably have a weight average molecular weight within the range from 5,000 kDa to 100,0000 kDa, more preferably within the range from 10,000 kDa to 80,000 kDa.

In some embodiments of the present disclosure, the modified polyrotaxane macromolecular chains preferably have a weight average molecular weight from 10 kDa to 100 kDa, more preferably from 30 kDa to 90 kDa.

In some embodiments of the present disclosure, the polycaprolactone shape memory material has an improved toughness, a large tensile strain, and excellent recovery properties, and is capable of remodeling the morphology. Preferably, the polycaprolactone shape memory material has an elongation at break of more than 900%, the polycaprolactone shape memory material has a gel content within the range from 37 wt % to 78 wt %, and the time for the polycaprolactone shape memory material to recover from 100% strain to an original shape is not more than 5 s.

In the present disclosure, the aforementioned structure of the polycaprolactone shape memory material can be determined through the analysis means combining Raman spectrum, gel content measurement, gel permeation chromatography (GPC), Fourier transform infrared spectrum, and ¹H NMR, or incorporating the reaction and feeding materials in the preparation process of synthesizing the material, and the reversible change process of the reversible linking group can be determined. The physicochemical properties of the polycaprolactone shape memory material can be measured, for example, the elongation at break is measured through mechanical property testing, and the gel content is measured through a Soxhlet extraction method. Both the shape recovery velocity and the shape recovery rate are measured through a plate heating and stretching method.

In the second aspect, the present disclosure provides a composition for preparing the polycaprolactone shape memory material of the present disclosure comprising a polyrotaxane initiator, an end group modifier, ϵ-caprolactone, a catalyst, and a cross-linking agent; wherein the end group modifier is selected from nitrocinnamate compounds and/or 4-((4-methyl-2-oxo-2H-chromene-7-yl)oxy)butyric acid.

the present disclosure provides the composition containing polyrotaxane as an initiator to initiate ring-opening polymerization of ϵ-caprolactone into slidable polycaprolactone molecular chains. The end group modifier can be used for modifying the end group moiety of the polycaprolactone into photo-reversible groups and modifying the cross-linking mode into a reversible bonding, thereby overcoming the problems concerning the toughness, designability, and remoldability of the existing polycaprolactone shape memory material.

In some embodiments of the present disclosure, the polyrotaxane initiator preferably has a weight average molecular weight from 10 kDa to 100 kDa, more preferably from 30 kDa to 90 kDa. The polyrotaxane initiator is commercially available or homemade, as long as the above requirements are satisfied.

In some embodiments of the present disclosure, the catalyst is preferably at least one selected from the group consisting of stannous octoate, lithium diisopropylamide, scandium trifluoromethane sulfonate, and phosphazene base (BEMP).

In some embodiments of the present disclosure, the crosslinking agent is preferably selected from diisocyanate, more preferably, the crosslinking agent is at least one selected from the group consisting of hexamethylene diisocyanate, toluene diisocyanate, isophorone diisocyanate, and lysine diisocyanate. The crosslinking agent can be provided for linking the different polycaprolactone macromolecular chains formed by ring-opening polymerization of ϵ-caprolactone.

In the present disclosure, the photo-reversible group may be a cinnamate group or a coumarin group, for example, the nitrocinnamate compound may be a compound with the previously mentioned structure, which is not repeatedly described herein, it can provide a cinnamate group; 4-((4-methyl-2-oxo-2H-chromene-7-yl)oxy)butyric acid can provide a coumarin group. The structural formula of 4-((4-methyl-2-oxo-2H-chromene-7-yl)oxy)butyric acid is shown as follows:

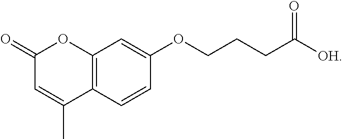 [SMILES: Cc1cc(=O)oc2cc(OCCCC(=O)O)ccc12]

The photo-reversible group can modify one end of the polycaprolactone macromolecular chains formed by ring-opening polymerization of ϵ-caprolactone, and then bond the photo-reversible groups of different polycaprolactone macromolecular chains, the formed structure is capable of reversibly breaking bond or bonding under irradiation of ultraviolet having different wavelengths, such that the obtained polycaprolactone shape memory material has designability and solid remoldability.

In some embodiments of the present disclosure, the composition preferably comprises the polyrotaxane initiator within a range from 0.01 wt % to 0.1 wt %, ϵ-caprolactone within a range from 99 wt %-99.99 wt%, the catalyst within a range from 0.5 wt % to 2 wt %, the end group modifier within a range from 0.02 wt % to 0.05 wt %, and the crosslinking agent within a range from 0.1 wt % to 1 wt %, based on the total weight of the composition.

In a third aspect, the present disclosure provides a method for preparing a polycaprolactone shape memory material comprising the following steps:
(1) subjecting the polyrotaxane to hydroxypropylation to obtain hydroxypropylated polyrotaxane;
(2) carrying out a ring-opening polymerization on the hydroxypropylated polyrotaxane and ϵ-caprolactone in the presence of a catalyst, to obtain a polycaprolactone grafted polyrotaxane copolymer;
(3) subjecting the polycaprolactone grafted polyrotaxane copolymer and photo-reversible groups of an end group modifier to a modification reaction to obtain a polymer network precursor, wherein the end group part of the polymer network precursor is modified into the photo-reversible group;
(4) promoting the reaction of the photo-reversible group to cross-link the polymer network precursor in the presence of a cross-linking agent and the action of heating and ultraviolet light, to prepare the polycaprolactone shape memory material.

In some embodiments of the present disclosure, preferably, the hydroxypropylation process in step (1) comprises: dissolving the polyrotaxane in an alkali solution, reacting with a hydroxylation reagent, and purifying and washing the obtained product. The hydroxylation reagent may be epoxy propane.

In some embodiments of the present disclosure, preferably, the catalyst in step (2) is at least one selected from the group consisting of stannous octoate, lithium diisopropylamide, scandium trifluoromethanesulfonate, and phosphazene base.

In some embodiments of the present disclosure, the used amount of the catalyst is preferably from 0.5 wt % to 2 wt %, more preferably from 0.8 wt % to 1.2 wt %, based on the total mass of the hydroxypropylated polyrotaxane and ϵ-caprolactone.

In some embodiments of the present disclosure, the mole ratio of the hydroxypropylated polyrotaxane in terms of the number of active hydroxyls contained therein to ϵ-caprolactone is preferably 1:(50-600), more preferably 1:(50-200). The number of active hydroxyls is determined by the ratio of the integrated area at a chemical shift of 1.1 ppm on the nuclear magnetic hydrogen spectrum to the integrated area of cyclodextrin.

In some embodiments of the present disclosure, the ring-opening polymerization temperature is preferably within the range from 100° C. to 140° C., more preferably within the range from 110° C. to 130° C., and the ring-opening polymerization time is preferably within the range of 40-50 h, more preferably within the range from 45 h to 50 h.

In some embodiments of the present disclosure, preferably, the process of ring-opening polymerization comprises: subjecting the mixture of hydroxypropylated polyrotaxane, ϵ-caprolactone and the catalyst to a polymerization reaction under the protection of nitrogen gas; dissolving the obtained primary product with tetrahydrofuran, then carrying out precipitation in n-hexane for many times, subsequently drying the obtained solid-phase precipitate to prepare the polycaprolactone grafted polyrotaxane copolymer.

In some embodiments of the present disclosure, preferably, the molar ratio of the end group modifier to the polycaprolactone grafted polyrotaxane copolymer in step (3) is (100-400):1.

In some embodiments of the present disclosure, preferably, the end group modifier is selected from compounds having a photo-reversible group, more preferably selected from nitrocinnamate compounds and/or 4-((4-methyl-2-oxo-2H-chromene-7-yl)oxy)butyric acid. The specific compounds are as previously described.

In some embodiments of the present disclosure, it is preferable that the temperature of the end group modification reaction is within the range from 40° C. to 60° C., and the time of the end group modification reaction is within the range from 15 h to 25 h.

In some embodiments of the present disclosure, the process of the end group modification reaction preferably comprises: mixing the end group modifier and the polycaprolactone grafted polyrotaxane copolymer respectively with a solution prepared with a first organic solvent, adding a water absorbent-I and an esterification catalyst into the obtained mixed solution, and then carrying out the end group modification reaction; subjecting the obtained initial product to precipitation for many times, and drying the obtained solid precipitate to obtain the polymer network precursor.

In some embodiments of the present disclosure, preferably, the first organic solvent is at least one selected from the group consisting of tetrahydrofuran, N,N-dimethylformamide, dichloromethane, and dioxane; the water absorbent-I is at least one selected from N,N-diisopropyl carbodiimide, dicyclohexyl carbodiimide, and concentrated sulfuric acid; the esterification catalyst is at least one selected from the group consisting of 4-dimethylamino pyridine, p-toluene sulfonic acid, and thionyl chloride.

In some embodiments of the present disclosure, the first organic solvent is used in an amount such that the concentration of the mixed solution is preferably within the range from 1 g/mL to 10 g/mL, more preferably within the range from 2 g/mL to 8 g/mL. That is, the total content of the end group modifier and the polycaprolactone grafted polyrotaxane copolymer contained in the mixed solution.

In some embodiments of the present disclosure, the used amount of the water absorbent-I is preferably from 1 wt % to 5 wt %, more preferably from 1.5 wt % to 4.5 wt % of the total amount of the end group modifier and the polycaprolactone grafted polyrotaxane copolymer.

In some embodiments of the present disclosure, the molar ratio of the esterification catalyst to the polycaprolactone grafted polyrotaxane copolymer is preferably 1:(1.5-3.5), more preferably 1:(2-3).

In some embodiments of the present disclosure, the photo-reversible group is derived from an end group modifier, it may be a cinnamate group or a coumarin group. Preferably, the polymer network precursor has a plurality of slidable polycaprolactone molecular chains, and a part of the chain ends of the polycaprolactone molecular chains contain a photo-reversible group derived from the end group modifier. For example, a part of the chain ends of the polycaprolactone molecular chain contains a hydroxyl group and a cinnamate group.

In some embodiments of the present disclosure, the crosslinking agent in step (4) is preferably selected from diisocyanates, more preferably at least one selected from the group consisting of hexamethylene diisocyanate, toluene diisocyanate, isophorone diisocyanate, and lysine diisocyanate. The modification reaction in step (3) may be incomplete, and not all the end groups of the polycaprolactone macromolecular chains in the polycaprolactone grafted polyrotaxane copolymer are modified into the photo-reversible groups, that is, the polymer network precursor may also contain the unmodified hydroxyl end groups of the polycaprolactone macromolecular chains so that the different polycaprolactone macromolecular chains can be thermally reversibly linked by the diisocyanate provided by the cross-linking agent. Meanwhile, the reconnection can be performed through the ester exchange, which is equivalent to the exchange connection of different polycaprolactone macromolecular chains by the same polycaprolactone macromolecular chains.

In some embodiments of the present disclosure, the used amount of the crosslinking agent is preferably from 0.1 wt % to 1 wt % of the polymer network precursor.

In some embodiments of the present disclosure, preferably, the heating temperature is within the range from 70° C. to 90° C., and the heating time is within the range from 45 h to 60 h.

In some embodiments of the present disclosure, the wavelength of the ultraviolet light is preferably within the range from 250 nm to 380 nm.

In some embodiments of the present disclosure, the crosslinking process preferably comprises: dissolving the polymer network precursor in a second organic solvent, and then adding a butyl acetate solution of the crosslinking agent and the crosslinking catalyst to obtain a liquid mixture; heating and drying the liquid mixture, then irradiating under the ultraviolet light to obtain the polycaprolactone shape memory material.

In some embodiments of the present disclosure, preferably, the second organic solvent is at least one selected from the group consisting of tetrahydrofuran, N,N-dimethylformamide, dichloromethane, and dioxane; the crosslinking catalyst is at least one selected from the group consisting of dibutyltin dilaurate, an organic bismuth catalyst, and N,N-dimethyl cyclohexylamine.

In some embodiments of the present disclosure, preferably, the second organic solvent is used in an amount such that the concentration of the liquid mixture is within the range from 1 g/mL to 10 g/mL, more preferably within the range from 2 g/mL to 8 g/mL. That is, the total content of the polymer network precursor, the crosslinking agent, and the crosslinking catalyst in the liquid mixture. The used amount of the crosslinking catalyst is from 1 wt % to 5 wt %, preferably from 2 wt % to 4 wt % of the polymer network precursor.

In some embodiments of the present disclosure, the polyrotaxane can be homemade. Preferably, the polyrotaxane is prepared with the following process: reacting α-cyclodextrin with polyethylene glycol diamine in the presence of a large steric hindrance compound.

In some embodiments of the present disclosure, the large steric hindrance compound is preferably at least one selected from the group consisting of N-benzyloxycarbonyl-L-tyrosine, 1-adamantane acetic acid, fluorescein isothiocyanate, and L-phenylalanine.

In some embodiments of the present disclosure, the polyethylene glycol diamine preferably has a weight average molecular weight from 5 kDa to 40 kDa, more preferably from 10 kDa to 35 kDa.

In some embodiments of the present disclosure, the molar ratio of α-cyclodextrin to the polyethylene glycol diamine is preferably (50-100):1, more preferably (80-90):1.

In some embodiments of the present disclosure, the molar ratio of the large steric hindrance compound to the polyethylene glycol diamine is preferably (2-10):1, more preferably (5-8):1.

In some embodiments of the present disclosure, preferably, the reaction process comprises the following steps:
(i) adding the polyethylene glycol diamine into a saturated aqueous solution of α-cyclodextrin, stirring at the temperature from 20° C. to 35° C. for a time from 20 h to 40 h, and drying the obtained white precipitate to obtain a clathrate compound;
(ii) dissolving the large steric hindrance compound, the amidation catalyst, and the water absorbent-II in a third organic solvent to prepare a solution, then adding the clathrate compound into the solution, subjecting the obtained suspension to an amidation reaction and then performing precipitation, and washing and drying the obtained solid-phase precipitate to prepare the polyrotaxane.

In some embodiments of the present disclosure, preferably, the amidation catalyst is at least one selected from the group consisting of BOP reagent, zinc chloride, and ferric chloride hexahydrate; the water absorbent-II is at least one selected from the group consisting of N,N-diisopropylethylamine, 1-hydroxybenzotriazole, and dicyclohexylcarbodiimide; the third organic solvent is at least one selected from the group consisting of N,N-dimethylformamide, tetrahydrofuran, and dichloromethane.

In some embodiments of the present disclosure, preferably, the used amount of the amidation catalyst is from 1 wt % to 5 wt %, more preferably from 2 wt % to 4 wt % of the total amount of the polyethylene glycol diamine and α-cyclodextrin; the used amount of the water absorbent agent-II is from 1 wt % to 5 wt %, more preferably from 2 wt % to 4 wt % of the total amount of the polyethylene glycol diamine and the α-cyclodextrin; the third organic solvent is used in an amount such that the concentration of the solution is within the range from 1 g/mL to 10 g/mL, more preferably within the range from 2 g/mL to 8 g/mL. That is, the total content of the large steric hindrance compound, the amidation catalyst, and the water-absorbing agent-II in the solution.

In some embodiments of the present disclosure, the polyrotaxane preferably has a weight average molecular weight within the range from 10 kDa to 100 kDa, more preferably within the range from 30 kDa to 90 kDa.

In a fourth aspect, the present disclosure provides a polycaprolactone shape memory material prepared with the method of the present disclosure.

In some embodiments of the present disclosure, preferably, the polycaprolactone shape memory material is provided with polycaprolactone molecular chains capable of slipping on the polyethylene glycol molecular chains, and can return to more than 95% of an original shape within 5 s; the material has a cross-linked structure, and has a photo-reversible dynamic covalent bond at a node moiety of the cross-linked structure, and the covalent bond can be broken under the irradiation of ultraviolet light with the wavelength of 256 nm so that the material has the capability of remolding the original shape in a solid state. The process demonstration of the shape remodeling of the polycaprolactone shape memory material is shown in FIG. 7. The polycaprolactone shape memory material has an elongation at break more than 900%, the polycaprolactone shape memory material has a gel content within the range from 37 wt % to 78 wt %, and the time for the polycaprolactone shape memory material to recover from 100% strain to an original shape is not more than 5 s.

In a fifth aspect, the present disclosure provides a use of the polycaprolactone shape memory material of the present disclosure in a medical recoverable fixation material.

Preferably, the use may include a shape memory medical fixation clamp.

The present disclosure will be described in detail below with reference to examples. In the following examples, ¹H-NMR spectrograms were measured with Bruker ARX-500 manufactured by the Bruker Corporation in Switzerland, wherein the resolution was lower than 0.2 Hz and the sensitivity was larger than 100. The nuclear magnetic resonance hydrogen spectrum analysis was performed, deuterated chloroform or deuterated dimethyl sulfoxide was used as a solvent, the working frequency was 500 MHz and the magnetic field intensity was 7.05T, and the testing was performed at the normal temperature.

The GPC spectrograms were obtained by using a triple detection size-exclusion chromatograph (TD-SEC) manufactured by the Waters corporation in the United States of America (USA), both the molecular weight and polymer dispersity index (PDI) of the polymer were characterized at 35° C., polystyrene was a standard sample, THF was a mobile phase, and the tested flow rate was 1.0 mL/min;

The Fourier transform infrared spectrogram was measured with Avatar 370 manufactured by the Nicolet Corporation in the USA, the KBr tablet was adopted for sample preparation, the transmission mode was adopted, and the scanned area was 500-4,000 cm⁻¹, the resolution was 2 cm⁻¹.

The gel content was measured by the Soxhlet extraction method and was obtained by weighing the sample before and after extraction with chloroform for 24 h.

Both the shape recovery velocity and the shape recovery rate were measured through a plate heating and stretching method, the parameters were measured by using a Q800 universal tester manufactured by the TA Instruments Corporation in the USA.

The produced PCL samples were prepared into dumbbell-shaped bars using a standard 4×25 cutter knife, mechanical property tests were performed using an electronic universal tester at a tensile rate of 20 mm/min and a preload of 0.5N, the elongation at break and the tensile strength of each sample were then calculated based on the following formulas. Before the test, the sample strip with 2 cm was from the middle of the sample strip and marked by a marker pen, the thickness of the film was measured three times at equal intervals at the marked part by using a standard vernier caliper, then the average value of the thickness was calculated, and the average thickness of the sample was recorded.

$$Elongation at break = \frac{{L}_{1} - {L}_{0}}{{L}_{0}}$$

$$Tensile strength = \frac{{F}_{max}}{A}$$

Wherein L₁ denoted the length of the sample at the break, L₀ was the initial length of the sample, Fₘₐₓ denoted the maximum tensile force during the stretching process, and A denoted the initial cross-sectional area of the sample.

### Example 1

The method of preparing the polycaprolactone re-mouldable shape memory material comprised the following steps:

Step 1: 5.3×10⁻⁵ mol of the polyethylene glycol diamine with a weight average molecular weight of 10 kDa was weighed, and added to a saturated aqueous solution of α-cyclodextrin (7.25 g/50 mL, double distilled H₂O). The mixture was stirred at room temperature for 24 h to obtain a white precipitate, which was then lyophilized in a lyophilizer for 48 h to obtain a clathrate.

2.6×10⁻³ mol of N-benzyloxycarbonyl-L-tyrosine (Z-L-Tyr), BOP reagent, 1-hydroxybenzotriazole (HOBt) and N,N-Diisopropylethylamine (DIEA) were dissolved in a small amount of N,N-Dimethylformamide (DMF) in sequence, the clathrate was added to the solution, the suspension was subjected to the amidation reaction at 25° C. for 24 h, the suspension was put in excessive ether to precipitate the initial product, and the precipitate was collected by centrifugation at 1,800 rpm for 20 min at room temperature, the precipitate was then continuously washed with a large amount of acetone, methanol, and water respectively and stirred for three times, the precipitate was lyophilized to obtain a polyrotaxane (PR).

An appropriate amount of polyrotaxane was weighed and dissolved in 50 mL of NaOH solution with a concentration of 1 mol/L, an appropriate amount of epoxy propane was dropwise added under the ice bath conditions, and the mixture was stirred overnight. The reaction temperature was gradually raised to room temperature as the ice in the solution melted. The samples were dialyzed and purified with deionized water for one week and then lyophilized. The lyophilized sample was poured into 100 mL of dichloromethane and stirred overnight to filter out free polyethylene glycol decomposed and generated during the hydroxypropylation process, subsequently washed with a large amount of acetone, and the precipitate was centrifugated and collected then dried under vacuum at 60° C. to obtain hydroxypropylated polyrotaxane (HP-PR).

Step 2: the HP-PR and purified ϵ-caprolactone (ϵ-CL) in a molar ratio (number of active hydroxyl on HP-PR: ϵ-CL=1:200) were fed into a dry and silanized round-bottomed flask, 1 wt. % of stannous octoate was added in terms of the total mass (i.e., the total weight of HP-PR and ϵ-caprolactone, similarly hereinafter), the high-purity nitrogen gas was introduced for replacing the air in said round-bottomed flask, the mixture was reacted at 120° C. for 48 h. The initial product was then dissolved with a small amount of tetrahydrofuran, precipitated in an excessive amount of n-hexane three times, and the precipitate was vacuum-dried at 60° C. for 48 h to obtain a polycaprolactone grafted polyrotaxane copolymer (PCL-g-PR).

Step 3: 0.5 molar equivalent of 4-nitrocinnamate of the number of active hydroxyl groups of HP-PR was weighed, and dissolved in 25 mL of DMF at 50° C., the DMF solution of PCL-g-PR was added to the DMF solution of 4-nitrocinnamic acid and stirred for 30 min. 1 molar equivalent of N,N-diisopropyl carbodiimide and 0.5 molar equivalent of 4-dimethylaminopyridine were subsequently added, the mixture was reacted at 50° C. for 20 h. The primary product was precipitated in excessive diethyl ether, and centrifuged to collect a solid, the solid product was dissolved in a small amount of toluene, then precipitated in diethyl ether three times, the precipitate was subjected to vacuum drying at 60° C. overnight to obtain a polymer network precursor, wherein the end groups were partially modified into the cinnamate groups.

Step 4: the polymer network precursor was dissolved in N,N-dimethylformamide at 80° C., a proper amount of n-butyl acetate solution of hexamethylene diisocyanate and dibutyltin dilaurate was added, and stirred for 5 min. The liquid mixture was rapidly disposed between two glass plates separated by a silicone rubber spacer, and placed in an oven at 80° C. for 48 h, subsequently dried under vacuum at 80° C. overnight, and finally irradiated in an ultraviolet oven under 4 UV lamps with a wavelength of 365 nm and a power of 5 W for 12 h, so that the polycaprolactone shape memory material was prepared.

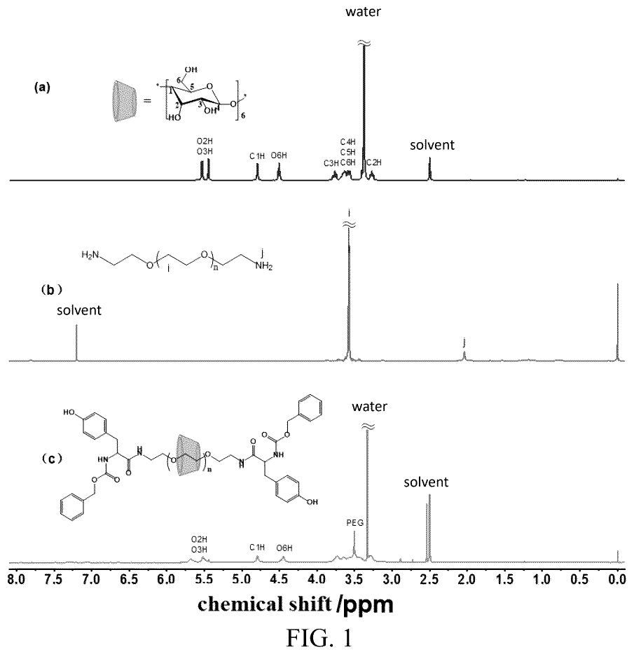

FIG. 1 illustrated a comparison diagram of the ¹H-NMR spectrogram of the prepared PR with PEG (polyethylene glycol) and α-CD: as shown in FIG. 1(a), the peak at a chemical shift of 3.28 ppm was the proton peak on the carbon atom labeled 2; the peaks at chemical shifts of 3.5-3.7ppm corresponded to proton peaks on the carbons atoms labeled 4, 5, and 6; the peak at a chemical shift of 3.76 ppm corresponded to the proton peak on the carbon atom labeled 3; the peak at a chemical shift of 4.51 ppm was the proton peak of the hydroxyl on carbon atom labeled 6; the peak at a chemical shift of 4.80 ppm was the proton peak on the carbon atom labeled 1; the peak at a chemical shift of 5.45 ppm was the proton peak of the hydroxyl on carbon atom labeled 3; the peak at chemical shift 5.54 ppm was the proton peak of the hydroxyl group on carbon atom labeled 2. As shown in FIG. 1(b), the peak (marked j) at the chemical shift of 2.04 ppm was a proton peak at the amine groups at both ends of PEG-NH₂; the peak at a chemical shift of 3.58 ppm (marked i) was the proton peak on the methylene group of PEG-NH₂. As shown in FIG. 1(c), the peak at a chemical shift of 3.51 ppm was the proton peak of the methylene group on PEG; the peaks at chemical shifts of 4.4-5.7 ppm were proton peaks on α-CD. As illustrated by the nuclear magnetic map, the synthesized PR nuclear magnetic map had a characteristic peak at 3.5 ppm of methylene of PEG and a characteristic peak at 4.8 ppm on the carbon atom labeled 1 on α-CD, indicating that the PR molecule contained PEG and α-CD structural units. When the characteristic peaks at 4.8 ppm and 3.5 ppm were subjected to integration respectively, it was found that ∫4.8:∫3.5=1:4, there was one α-CD molecule on about six PEG structural units on average.

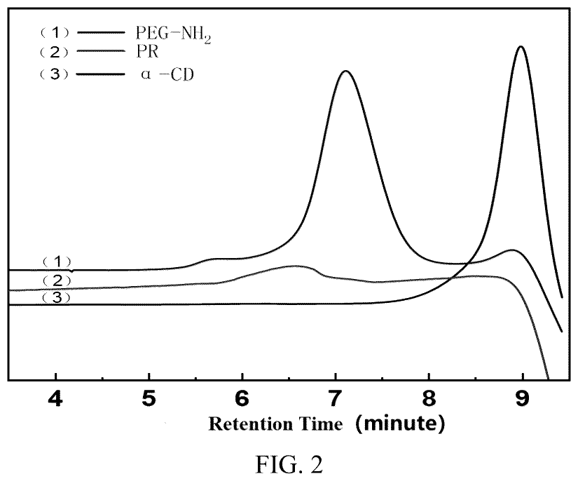

FIG. 2 illustrated a GPC comparison diagram of the prepared PR with PEG-NH₂ and α-CD, as shown by the respective retention times, PR had a significantly greater molecular weight than PEG-NH₂ and did not contain small molecule component; with reference to the nuclear magnetic data shown in FIG. 1, it indicated that the α-CD found in the nuclear magnetic map was successfully put on the PEG molecular chain and PR was successfully synthesized.

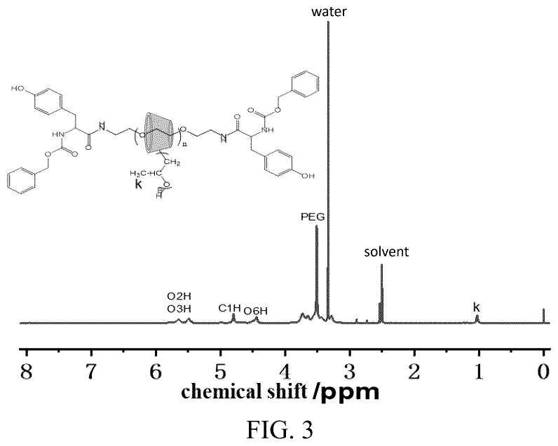

FIG. 3 illustrated the HP-PR nuclear magnetism spectrogram of the prepared hydroxypropyl after modification, its positions were almost the same as those of PR above 2.0 ppm as shown in the nuclear magnetism spectrogram, but there was an additional proton peak of methyl at the chemical shift of 1.0 ppm (marked k) of the HP-PR, it indicated that the α-CD on PR was successfully modified by the hydroxypropyl. The peaks at 4.2-6.0 ppm and 1.0 ppm were integrated, and the hydroxypropyl modification rate DS of PR was calculated as 6 based on the area integration ratio of the peaks at 4.2-6.0 ppm relative to the peak at 1.0 ppm.

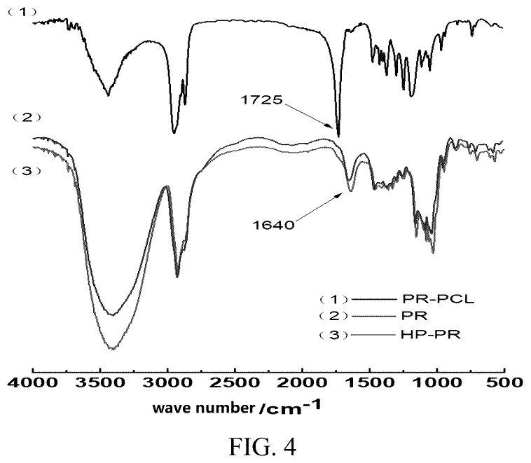

FIG. 4 illustrated an infrared comparison diagram of the prepared PR, HP-PR, and PCL-g-PR, wherein the absorption peak at 3436 cm⁻¹ and the absorption peaks at 3400 cm⁻¹ of the PR and HP-PR were attributed to the stretching vibration of —O—H on the group —OH and —N—H on the group-NH—; the absorption peak at 2946 cm⁻¹ of PCL-g-PR and the absorption peak at 2923 cm⁻¹ of the PR and HP-PR were attributed to the asymmetric stretching vibration of —C—H on the group —CH₂—, while the absorption peak at 2866 cm⁻¹ of PCL-g-PR was attributed to the symmetric stretching vibration of —C—H on the group —CH₂—; the absorption peak at 1725 cm⁻¹ of PCL-g-PR was attributed to stretching vibration of carbonyl group (C═O) on a side chain of polycaprolactone, while the absorption peak at 1640 cm⁻¹ of the PR and HP-PR was attributed to stretching vibration of carbonyl group (C═O) on an amide bond; the absorption peaks at 1300-1500 cm⁻¹ of the PR, HP-PR, and PCL-g-PR were attributed to C—H in-plane bending vibration, the absorption peaks at 1000-1300 cm⁻¹ were caused by the C—C skeleton vibration, and the absorption peak at 650-1000 cm⁻¹ was attributed to C—H out-of-plane bending vibration. The carbonyl peaks found in the PR and HP-PR were attributed to amide bonds, while the carbonyl peaks found in the PCL-g-PR had a higher frequency and were corresponding to the ester bonds, which indicated that ring-opening polymerization of ϵ-caprolactone was successfully initiated by using HP-PR as an initiator so that the macromolecular ester bonds were formed. The infrared characteristic peaks of the PR and the HP-PR were almost the same, but the characteristic peak of HP-PR had a higher intensity, probably because after the α-cyclodextrin on PR was hydroxypropylated, the hydrogen bonds between the α-cyclodextrin were weakened, thus the vibration frequency among atoms was larger.

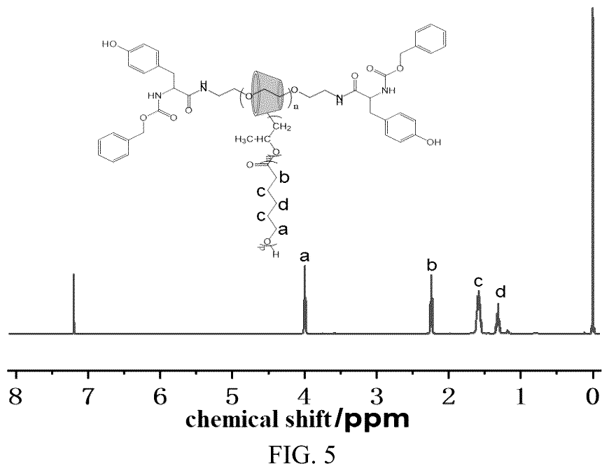

FIG. 5 illustrated a nuclear magnetic spectrogram of the prepared PCL-g-PR, the peak at a chemical shift of 1.32 ppm (marked d) corresponded to the proton peak on a methylene at the middlemost of the caprolactone chain segment; the peak at a chemical shift of 1.58 ppm (marked c) corresponded to the proton peak on a methylene adjacent to the middle carbon atom in the caprolactone segment; the peak at a chemical shift of 2.24 ppm (marked b) corresponded to the proton peak at the ortho carbon in the carbonyl of the caprolactone segment; the peak at a chemical shift of 3.99 ppm (marked a) corresponded to the proton peak at the ortho carbon relative to an oxygen atom of the caprolactone segment; a suspected weak characteristic peak of the PEG methylene existed at the chemical shift of 3.58 ppm, the reason may be that the methylene proton peak signals on the PEG chain were shielded due to the growth of a PCL chain segment of a PCL-g-PR side chain.

FIG. 6 illustrated a schematic view showing the cross-linked network structure of the material, which was exemplified by the polycaprolactone shape memory material prepared in Example 1. The polyethylene glycol macromolecular chains were provided with large steric hindrance groups (derived from N-benzyloxycarbonyl-L-tyrosine) shown as round dots and passed through α-cyclodextrin shown as circular rings carried on the polycaprolactone macromolecular chains to form a cross-linked network structure of the polyethylene glycol macromolecular chains and the polycaprolactone macromolecular chains, and the polycaprolactone macromolecular chains were capable of sliding on the polyethylene glycol macromolecular chains via the loop structure provided by the α-cyclodextrin. There was also reversible linking groups, which provided the reversible covalent bond and were schematically shown as a square block, on the polycaprolactone macromolecular chains, the reversible linking groups were formed by the photo-reversible groups provided by the end group modifier or the thermally-reversible group provided by the cross-linker, and were capable of introducing dynamic covalent bond for the polycaprolactone shape memory material, and realizing reversible bond, thereby achieving the complex shape designability and solid remoldability of the shape memory material.

### Example 2

The method of preparing the polycaprolactone re-mouldable shape memory material

comprised the following steps:

Step 1: 6.4×10⁻⁵ mol of the polyethylene glycol diamine with a weight average molecular weight of 15 kDa was weighed, and added to a saturated aqueous solution of α-cyclodextrin (7.25 g/50 mL, double distilled H₂O). The mixture was stirred at 30° C. for 30 h to obtain a white precipitate, which was then lyophilized in a lyophilizer for 48 h to obtain a clathrate.

3.4×10⁻³ mol of N-benzyloxycarbonyl-L-tyrosine (Z-L-Tyr), BOP reagent, 1-hydroxybenzotriazole (HOBt) and N,N-Diisopropylethylamine (DIEA) were dissolved in a small amount of N,N-Dimethylformamide (DMF) in sequence, the clathrate was added to the solution, the suspension was subjected to the amidation reaction at 25° C. for 26 h, the suspension was put in excessive ether to precipitate the initial product, and the precipitate was collected by centrifugation at 1,800 rpm for 25 min at room temperature, the precipitate was then continuously washed with a large amount of acetone, methanol, and water respectively and stirred for three times, the precipitate was lyophilized to obtain a polyrotaxane (PR).

An appropriate amount of polyrotaxane was weighed and dissolved in 50 mL of NaOH solution with a concentration of 1 mol/L, an appropriate amount of epoxy propane was dropwise added under the ice bath conditions, and the mixture was stirred overnight. The reaction temperature was gradually raised to room temperature as the ice in the solution melted. The samples were dialyzed and purified with deionized water for one week and then lyophilized. The lyophilized sample was poured into 100 mL of dichloromethane and stirred overnight to filter out free polyethylene glycol decomposed and generated during the hydroxypropylation process, subsequently washed with a large amount of acetone, and the precipitate was centrifugated and collected then dried under vacuum at 55° C. to obtain hydroxypropylated polyrotaxane (HP-PR).

Step 2: the HP-PR and purified E-caprolactone (ϵ-CL) in a molar ratio (number of active hydroxyl on HP-PR: ϵ-CL=1:100) were fed into a dry and silanized round-bottomed flask, 1 wt. % of stannous octoate was added in terms of the total mass (i.e., the total weight of HP-PR and ϵ-caprolactone, similarly hereinafter), the high-purity nitrogen gas was introduced for replacing the air in said round-bottomed flask, the mixture was reacted at 130° C. for 50 h. The initial product was then dissolved with a small amount of tetrahydrofuran, precipitated in an excessive amount of n-hexane three times, and the precipitate was vacuum-dried at 60° C. for 48 h to obtain a polycaprolactone grafted polyrotaxane copolymer (PCL-g-PR).

Step 3: 0.5 molar equivalent of 4-nitrocinnamate of the number of active hydroxyl groups of HP-PR was weighed, and dissolved in 25 mL of DMF at 50° C., the DMF solution of PCL-g-PR was added to the DMF solution of 4-nitrocinnamic acid and stirred for 40 min. 1 molar equivalent of N,N-diisopropyl carbodiimide, and 0.5 molar equivalent of 4-dimethylaminopyridine were subsequently added, and the mixture was reacted at 55° C. for 22 h. The primary product was precipitated in excessive diethyl ether, and centrifuged to collect a solid, the solid product was dissolved in a small amount of toluene, then precipitated in diethyl ether three times, the precipitate was subjected to vacuum drying at 60° C. overnight to obtain a polymer network precursor, wherein the end groups were partially modified into the cinnamate groups.

Step 4: the polymer network precursor was dissolved in N,N-dimethylformamide at 80° C., a proper amount of n-butyl acetate solution of hexamethylene diisocyanate and dibutyltin dilaurate was added, and stirred for 5 min. The liquid mixture was rapidly disposed between two glass plates separated by a silicone rubber spacer, and placed in an oven at 80° C. for 48 h, subsequently dried under vacuum at 80° C. overnight, and finally irradiated in an ultraviolet oven under 4 UV lamps with a wavelength of 370 nm and a power of 5 W for 12 h, so that the polycaprolactone shape memory material was prepared.

### Example 3

The method of preparing the polycaprolactone re-mouldable shape memory material comprised the following steps:

Step 1: 8.0×10⁻⁵ mol of the polyethylene glycol diamine with a weight average molecular weight of 20 kDa was weighed, and added to a saturated aqueous solution of α-cyclodextrin (7.25 g/50 mL, double distilled H₂O). The mixture was stirred at room temperature for 24 h to obtain a white precipitate, which was then lyophilized in a lyophilizer for 48 h to obtain a clathrate.

4.2×10⁻³ mol of N-benzyloxycarbonyl-L-tyrosine (Z-L-Tyr), BOP reagent, 1-hydroxybenzotriazole (HOBt) and N,N-Diisopropylethylamine (DIEA) were dissolved in a small amount of N,N-Dimethylformamide (DMF) in sequence, the clathrate was added to the solution, the suspension was subjected to the amidation reaction at 30° C. for 25 h, the suspension was put in excessive ether to precipitate the initial product, and the precipitate was collected by centrifugation at 2,200 rpm for 15 min at room temperature, the precipitate was then continuously washed with a large amount of acetone, methanol, and water respectively and stirred for three times, the precipitate was lyophilized to obtain a polyrotaxane (PR).

An appropriate amount of polyrotaxane was weighed and dissolved in 50 mL of NaOH solution with a concentration of 1 mol/L, an appropriate amount of epoxy propane was dropwise added under the ice bath conditions, and the mixture was stirred overnight. The reaction temperature was gradually raised to room temperature as the ice in the solution melted. The samples were dialyzed and purified with deionized water for one week and then lyophilized. The lyophilized sample was poured into 100 mL of dichloromethane and stirred overnight to filter out free polyethylene glycol decomposed and generated during the hydroxypropylation process, subsequently washed with a large amount of acetone, and the precipitate was centrifugated and collected then dried under vacuum at 60° C. to obtain hydroxypropylated polyrotaxane (HP-PR).

Step 2: the HP-PR and purified ϵ-caprolactone (ϵ-CL) in a molar ratio (number of active hydroxyl on HP-PR: ϵ-CL=1:600) were fed into a dry and silanized round-bottomed flask, 1 wt. % of stannous octoate was added in terms of the total mass (i.e., the total weight of HP-PR and ϵ-caprolactone, similarly hereinafter), the high-purity nitrogen gas was introduced for replacing the air in said round-bottomed flask, the mixture was reacted at 130° C. for 55 h. The initial product was then dissolved with a small amount of tetrahydrofuran, precipitated in an excessive amount of n-hexane three times, and the precipitate was vacuum-dried at 60° C. for 48 h to obtain a polycaprolactone grafted polyrotaxane copolymer (PCL-g-PR).

Step 3: 0.5 molar equivalent of 4-nitrocinnamate of the number of active hydroxyl groups of HP-PR was weighed, and dissolved in 25 mL of DMF at 50° C., the DMF solution of PCL-g-PR was added to the DMF solution of 4-nitrocinnamic acid and stirred for 30 min. 1 molar equivalent of N,N-diisopropyl carbodiimide and 0.5 molar equivalent of 4-dimethylaminopyridine were subsequently added, the mixture was reacted at 45° C. for 15 h. The primary product was precipitated in excessive diethyl ether, and centrifuged to collect a solid, the solid product was dissolved in a small amount of toluene, then precipitated in diethyl ether three times, the precipitate was subjected to vacuum drying at 60° C. overnight to obtain a polymer network precursor, wherein the end groups were partially modified into the cinnamate groups.

Step 4: the polymer network precursor was dissolved in N,N-dimethylformamide at 80° C., a proper amount of n-butyl acetate solution of hexamethylene diisocyanate and dibutyltin dilaurate was added, and stirred for 5 min. The liquid mixture was rapidly disposed between two glass plates separated by a silicone rubber spacer, and placed in an oven at 80° C. for 48 h, subsequently dried under vacuum at 80° C. overnight, and finally irradiated in an ultraviolet oven under 4 UV lamps with a wavelength of 380 nm and a power of 5 W for 10 h, so that the polycaprolactone shape memory material was prepared.

### Example 4

The method of preparing the polycaprolactone shape memory material comprised the following steps:

Step 1: 5.3×10⁻⁵ mol of the polyethylene glycol diamine with a weight average molecular weight of 20 kDa was weighed, and added to a saturated aqueous solution of α-cyclodextrin (7.25 g/50 mL, double distilled H₂O). The mixture was stirred at room temperature for 24 h to obtain a white precipitate, which was then lyophilized in a lyophilizer for 48 h to obtain a clathrate.

2.6×10⁻³ mol of N-benzyloxycarbonyl-L-tyrosine (Z-L-Tyr), BOP reagent, 1-hydroxybenzotriazole (HOBt) and N,N-Diisopropylethylamine (DIEA) were dissolved in a small amount of N,N-Dimethylformamide (DMF) in sequence, the clathrate was added to the solution, the suspension was subjected to the amidation reaction at 25° C. for 30 h, the suspension was put in excessive ether to precipitate the initial product, and the precipitate was collected by centrifugation at 2,000 rpm for 25 min at room temperature, the precipitate was then continuously washed with a large amount of acetone, methanol and water respectively and stirred for three times, the precipitate was lyophilized to obtain a polyrotaxane (PR).

An appropriate amount of polyrotaxane was weighed and dissolved in 50 mL of NaOH solution with a concentration of 1 mol/L, an appropriate amount of epoxy propane was dropwise added under the ice bath conditions, and the mixture was stirred overnight. The reaction temperature was gradually raised to room temperature as the ice in the solution melted. The samples were dialyzed and purified with deionized water for one week and then lyophilized. The lyophilized sample was poured into 100 mL of dichloromethane and stirred overnight to filter out free polyethylene glycol decomposed and generated during the hydroxypropylation process, subsequently washed with a large amount of acetone, and the precipitate was centrifugated and collected then dried under vacuum at 60° C. to obtain hydroxypropylated polyrotaxane (HP-PR).

Step 2: the HP-PR and purified ϵ-caprolactone (ϵ-CL) in a molar ratio (number of active hydroxyl on HP-PR: ϵ-CL=1:200) were fed into a dry and silanized round-bottomed flask, 1 wt. % of stannous octoate was added in terms of the total mass (i.e., the total weight of HP-PR and ϵ-caprolactone, similarly hereinafter), the high-purity nitrogen gas was introduced for replacing the air in said round-bottomed flask, the mixture was reacted at 120° C. for 48 h. The initial product was then dissolved with a small amount of tetrahydrofuran, precipitated in an excessive amount of n-hexane three times, and the precipitate was vacuum-dried at 60° C. for 48 h to obtain a polycaprolactone grafted polyrotaxane copolymer (PCL-g-PR).

Step 3: 0.5 molar equivalent of 4-nitrocinnamate of the number of active hydroxyl groups of HP-PR was weighed, and dissolved in 25 mL of DMF at 50° C., the DMF solution of PCL-g-PR was added to the DMF solution of 4-nitrocinnamic acid and stirred for 30 min. 1 molar equivalent of N,N-diisopropyl carbodiimide and 0.5 molar equivalent of 4-dimethylaminopyridine were subsequently added, the mixture was reacted at 60° C. for 15 h. The primary product was precipitated in excessive diethyl ether, and centrifuged to collect a solid, the solid product was dissolved in a small amount of toluene, then precipitated in diethyl ether three times, the precipitate was subjected to vacuum drying at 60° C. overnight to obtain a polymer network precursor, wherein the end groups were partially modified into the cinnamate groups.

Step 4: the polymer network precursor was dissolved in N,N-dimethylformamide at 80° C., a proper amount of n-butyl acetate solution of hexamethylene diisocyanate and dibutyltin dilaurate was added, and stirred for 5 min. The liquid mixture was rapidly disposed between two glass plates separated by a silicone rubber spacer, and placed in an oven at 80° C. for 48 h, subsequently dried under vacuum at 80° C. overnight, and finally irradiated in an ultraviolet oven under 4 UV lamps with a wavelength of 375 nm and a power of 5 W for 13 h, so that the polycaprolactone shape memory material was prepared.

### Example 5

The method of preparing the polycaprolactone shape memory material comprised the following steps:

Step 1: 5.7×10⁻⁵ mol of the polyethylene glycol diamine with a weight average molecular weight of 20 kDa was weighed, and added to a saturated aqueous solution of α-cyclodextrin (7.25 g/50 mL, double distilled H₂O). The mixture was stirred at 30° C. for 24 h to obtain a white precipitate, which was then lyophilized in a lyophilizer for 50 h to obtain a clathrate.

2.7×10⁻³ mol of N-benzyloxycarbonyl-L-tyrosine (Z-L-Tyr), BOP reagent, 1-hydroxybenzotriazole (HOBt) and N,N-Diisopropylethylamine (DIEA) were dissolved in a small amount of N,N-Dimethylformamide (DMF) in sequence, the clathrate was added to the solution, the suspension was subjected to the amidation reaction at 25° C. for 28 h, the suspension was put in excessive ether to precipitate the initial product, and the precipitate was collected by centrifugation at 1,800 rpm for 30 min at room temperature, the precipitate was then continuously washed with a large amount of acetone, methanol, and water respectively and stirred for three times, the precipitate was lyophilized to obtain a polyrotaxane (PR).

An appropriate amount of polyrotaxane was weighed and dissolved in 50 mL of NaOH solution with a concentration of 1 mol/L, an appropriate amount of epoxy propane was dropwise added under the ice bath conditions, and the mixture was stirred overnight. The reaction temperature was gradually raised to room temperature as the ice in the solution melted. The samples were dialyzed and purified with deionized water for one week and then lyophilized. The lyophilized sample was poured into 100 mL of dichloromethane and stirred overnight to filter out free polyethylene glycol decomposed and generated during the hydroxypropylation process, subsequently washed with a large amount of acetone, and the precipitate was centrifugated and collected then dried under vacuum at 60° C. to obtain hydroxypropylated polyrotaxane (HP-PR).

Step 2: the HP-PR and purified ϵ-caprolactone (ϵ-CL) in a molar ratio (number of active hydroxyl on HP-PR: ϵ-CL=1:400) were fed into a dry and silanized round-bottomed flask, 1 wt. % of stannous octoate was added in terms of the total mass, the high-purity nitrogen gas was introduced for replacing the air in said round-bottomed flask, the mixture was reacted at 125° C. for 50 h. The initial product was then dissolved with a small amount of tetrahydrofuran, precipitated in an excessive amount of n-hexane three times, and the precipitate was vacuum-dried at 60° C. for 48 h to obtain a polycaprolactone grafted polyrotaxane copolymer (PCL-g-PR).

Step 3: 0.5 molar equivalent of 4-nitrocinnamate of the number of active hydroxyl groups of HP-PR was weighed, and dissolved in 25 mL of DMF at 50° C., the DMF solution of PCL-g-PR was added to the DMF solution of 4-nitrocinnamic acid and stirred for 30 min. 1 molar equivalent of N,N-diisopropyl carbodiimide and 0.5 molar equivalent of 4-dimethylaminopyridine were subsequently added, the mixture was reacted at 40° C. for 25 h. The primary product was precipitated in excessive diethyl ether, and centrifuged to collect a solid, the solid product was dissolved in a small amount of toluene, then precipitated in diethyl ether three times, the precipitate was subjected to vacuum drying at 60° C. overnight to obtain a polymer network precursor, wherein the end groups were partially modified into the cinnamate groups.

Step 4: the polymer network precursor was dissolved in N,N-dimethylformamide at 80° C., a proper amount of n-butyl acetate solution of hexamethylene diisocyanate and dibutyltin dilaurate was added, and stirred for 5 min. The liquid mixture was rapidly disposed between two glass plates separated by a silicone rubber spacer, and placed in an oven at 80° C. for 48 h, subsequently dried under vacuum at 80° C. overnight, and finally irradiated in an ultraviolet oven under 4 UV lamps with a wavelength of 365 nm and a power of 5 W for 15 h, so that the polycaprolactone shape memory material was prepared.

### Example 6

The method of preparing the polycaprolactone re-mouldable shape memory material comprised the following steps:

Step 1: 7.4×10⁻⁵ mol of the polyethylene glycol diamine with a weight average molecular weight of 30 kDa was weighed, and added to a saturated aqueous solution of α-cyclodextrin (7.25 g/50 mL, double distilled H₂O). The mixture was stirred at room temperature for 24 h to obtain a white precipitate, which was then lyophilized in a lyophilizer for 48 h to obtain a clathrate.

3.5×10⁻³ mol of N-benzyloxycarbonyl-L-tyrosine (Z-L-Tyr), BOP reagent, 1-hydroxybenzotriazole (HOBt) and N,N-Diisopropylethylamine (DIEA) were dissolved in a small amount of N,N-Dimethylformamide (DMF) in sequence, the clathrate was added to the solution, the suspension was subjected to the amidation reaction at 25° C. for 24 h, the suspension was put in excessive ether to precipitate the initial product, and the precipitate was collected by centrifugation at 1,800 rpm for 30 min at room temperature, the precipitate was then continuously washed with a large amount of acetone, methanol, and water respectively and stirred for three times, the precipitate was lyophilized to obtain a polyrotaxane (PR).

An appropriate amount of polyrotaxane was weighed and dissolved in 50 mL of NaOH solution with a concentration of 1 mol/L, an appropriate amount of epoxy propane was dropwise added under the ice bath conditions, and the mixture was stirred overnight. The reaction temperature was gradually raised to room temperature as the ice in the solution melted. The samples were dialyzed and purified with deionized water for one week and then lyophilized. The lyophilized sample was poured into 100 mL of dichloromethane and stirred overnight to filter out free polyethylene glycol decomposed and generated during the hydroxypropylation process, subsequently washed with a large amount of acetone, and the precipitate was centrifugated and collected then dried under vacuum at 60° C. to obtain hydroxypropylated polyrotaxane (HP-PR).

Step 2: the HP-PR and purified ϵ-caprolactone (ϵ-CL) in a molar ratio (number of active hydroxyl on HP-PR: ϵ-CL=1:600) were fed into a dry and silanized round-bottomed flask, 1 wt. % of stannous octoate was added in terms of the total mass, the high-purity nitrogen gas was introduced for replacing the air in said round-bottomed flask, the mixture was reacted at 110° C. for 50 h. The initial product was then dissolved with a small amount of tetrahydrofuran, precipitated in an excessive amount of n-hexane three times, and the precipitate was vacuum-dried at 60° C. for 48 h to obtain a polycaprolactone grafted polyrotaxane copolymer (PCL-g-PR).

Step 3: 0.5 molar equivalent of 4-nitrocinnamate of the number of active hydroxyl groups of HP-PR was weighed, and dissolved in 25 mL of DMF at 50° C., the DMF solution of PCL-g-PR was added to the DMF solution of 4-nitrocinnamic acid and stirred for 40 min. 1 molar equivalent of N,N-diisopropyl carbodiimide, and 0.5 molar equivalent of 4-dimethylaminopyridine were subsequently added, and the mixture was reacted at 60° C. for 20 h. The primary product was precipitated in excessive diethyl ether, and centrifuged to collect a solid, the solid product was dissolved in a small amount of toluene, then precipitated in diethyl ether three times, the precipitate was subjected to vacuum drying at 60° C. overnight to obtain a polymer network precursor, wherein the end groups were partially modified into the cinnamate groups.

Step 4: the polymer network precursor was dissolved in N,N-dimethylformamide at 80° C., a proper amount of n-butyl acetate solution of hexamethylene diisocyanate and dibutyltin dilaurate was added, and stirred for 10 min. The liquid mixture was rapidly disposed between two glass plates separated by a silicone rubber spacer, and placed in an oven at 80° C. for 48 h, subsequently dried under vacuum at 80° C. overnight, and finally irradiated in an ultraviolet oven under 4 UV lamps with a wavelength of 380 nm and a power of 5 W for 12 h, so that the polycaprolactone shape memory material was prepared.

### Example 7

The method of preparing the polycaprolactone shape memory material comprised the following steps:

Step 1: 5.3×10⁻⁵ mol of the polyethylene glycol diamine with a weight average molecular weight of 35 kDa was weighed, and added to a saturated aqueous solution of α-CD (7.25 g/50 mL, double distilled H₂O). The mixture was stirred at 30° C. for 26 h to obtain a white precipitate, which was then lyophilized in a lyophilizer for 48 h to obtain a clathrate.

2.6×10⁻³ mol of N-benzyloxycarbonyl-L-tyrosine (Z-L-Tyr), BOP reagent, 1-hydroxybenzotriazole (HOBt) and N,N-Diisopropylethylamine (DIEA) were dissolved in a small amount of N,N-Dimethylformamide (DMF) in sequence, the clathrate was added to the solution, the suspension was subjected to the amidation reaction at 25° C. for 24 h, the suspension was put in excessive ether to precipitate the initial product, and the precipitate was collected by centrifugation at 2,000 rpm for 20 min at room temperature, the precipitate was then continuously washed with a large amount of acetone, methanol, and water respectively and stirred for three times, the precipitate was lyophilized to obtain a polyrotaxane (PR).

An appropriate amount of polyrotaxane was weighed and dissolved in 50 mL of NaOH solution with a concentration of 1 mol/L, an appropriate amount of epoxy propane was dropwise added under the ice bath conditions, and the mixture was stirred overnight. The reaction temperature was gradually raised to room temperature as the ice in the solution melted. The samples were dialyzed and purified with deionized water for one week and then lyophilized. The lyophilized sample was poured into 100 mL of dichloromethane and stirred overnight to filter out free polyethylene glycol decomposed and generated during the hydroxypropylation process, subsequently washed with a large amount of acetone, and the precipitate was centrifugated and collected then dried under vacuum at 60° C. to obtain hydroxypropylated polyrotaxane (HP-PR).

Step 2: the HP-PR and purified ϵ-caprolactone (ϵ-CL) in a molar ratio (number of active hydroxyl on HP-PR: ϵ-CL=1:200) were fed into a dry and silanized round-bottomed flask, 1 wt. % of stannous octoate was added in terms of the total mass, the high-purity nitrogen gas was introduced for replacing the air in said round-bottomed flask, the mixture was reacted at 130° C. for 45 h. The initial product was then dissolved with a small amount of tetrahydrofuran, precipitated in an excessive amount of n-hexane three times, and the precipitate was vacuum-dried at 60° C. for 48 h to obtain a polycaprolactone grafted polyrotaxane copolymer (PCL-g-PR).

Step 3:0.5 molar equivalent of 4-nitrocinnamate of the number of active hydroxyl groups of HP-PR was weighed, and dissolved in 25 mL of DMF at 50° C., the DMF solution of PCL-g-PR was added to the DMF solution of 4-nitrocinnamic acid and stirred for 30 min. 1 molar equivalent of N,N-diisopropyl carbodiimide and 0.5 molar equivalent of 4-dimethylaminopyridine were subsequently added, the mixture was reacted at 50° C. for 20 h. The primary product was precipitated in excessive diethyl ether, and centrifuged to collect a solid, the solid product was dissolved in a small amount of toluene, then precipitated in diethyl ether three times, the precipitate was subjected to vacuum drying at 60° C. overnight to obtain a polymer network precursor, wherein the end groups were partially modified into the cinnamate groups.

Step 4: the polymer network precursor was dissolved in N,N-dimethylformamide at 80° C., a proper amount of n-butyl acetate solution of hexamethylene diisocyanate and dibutyltin dilaurate was added, and stirred for 5 min. The liquid mixture was rapidly disposed between two glass plates separated by a silicone rubber spacer, and placed in an oven at 80° C. for 48 h, subsequently dried under vacuum at 80° C. overnight, and finally irradiated in an ultraviolet oven under 4 UV lamps with a wavelength of 370 nm and a power of 5 W for 15 h, so that the polycaprolactone shape memory material was prepared.

### Example 8

The method of preparing the polycaprolactone shape memory material comprised the following steps:

Step 1: 6.9×10⁻⁵ mol of the polyethylene glycol diamine with a weight average molecular weight of 35 kDa was weighed, and added to a saturated aqueous solution of α-CD (7.25 g/50 mL, double distilled H₂O). The mixture was stirred at room temperature for 24 h to obtain a white precipitate, which was then lyophilized in a lyophilizer for 48 h to obtain a clathrate.

3.5×10⁻³ mol of N-benzyloxycarbonyl-L-tyrosine (Z-L-Tyr), BOP reagent, 1-hydroxybenzotriazole (HOBt) and N,N-Diisopropylethylamine (DIEA) were dissolved in a small amount of N,N-Dimethylformamide (DMF) in sequence, the clathrate was added to the solution, the suspension was subjected to the amidation reaction at 25° C. for 26 h, the suspension was put in excessive ether to precipitate the initial product, and the precipitate was collected by centrifugation at 1,800 rpm for 30 min at room temperature, the precipitate was then continuously washed with a large amount of acetone, methanol, and water respectively and stirred for three times, the precipitate was lyophilized to obtain a polyrotaxane (PR).

An appropriate amount of polyrotaxane was weighed and dissolved in 50 mL of NaOH solution with a concentration of 1 mol/L, an appropriate amount of epoxy propane was dropwise added under the ice bath conditions, and the mixture was stirred overnight. The reaction temperature was gradually raised to room temperature as the ice in the solution melted. The samples were dialyzed and purified with deionized water for one week and then lyophilized. The lyophilized sample was poured into 100 mL of dichloromethane and stirred overnight to filter out free polyethylene glycol decomposed and generated during the hydroxypropylation process, subsequently washed with a large amount of acetone, and the precipitate was centrifugated and collected then dried under vacuum at 60° C. to obtain hydroxypropylated polyrotaxane (HP-PR).

Step 2: the HP-PR and purified ϵ-caprolactone (ϵ-CL) in a molar ratio (number of active hydroxyl on HP-PR: ϵ-CL=1:400) were fed into a dry and silanized round-bottomed flask, 1 wt. % of stannous octoate was added in terms of the total mass, the high-purity nitrogen gas was introduced for replacing the air in said round-bottomed flask, the mixture was reacted at 110° C. for 50 h. The initial product was then dissolved with a small amount of tetrahydrofuran, precipitated in an excessive amount of n-hexane three times, and the precipitate was vacuum-dried at 60° C. for 48 h to obtain a polycaprolactone grafted polyrotaxane copolymer (PCL-g-PR).

Step 3: 0.5 molar equivalent of 4-nitrocinnamate of the number of active hydroxyl groups of HP-PR was weighed, and dissolved in 25 mL of DMF at 50° C., the DMF solution of PCL-g-PR was added to the DMF solution of 4-nitrocinnamic acid and stirred for 30 min. 1 molar equivalent of N,N-diisopropyl carbodiimide and 0.5 molar equivalent of 4-dimethylaminopyridine were subsequently added, the mixture was reacted at 60° C. for 20 h. The primary product was precipitated in excessive diethyl ether, and centrifuged to collect a solid, the solid product was dissolved in a small amount of toluene, then precipitated in diethyl ether three times, the precipitate was subjected to vacuum drying at 60° C. overnight to obtain a polymer network precursor, wherein the end groups were partially modified into the cinnamate groups.

Step 4: the polymer network precursor was dissolved in N,N-dimethylformamide at 80° C., a proper amount of n-butyl acetate solution of hexamethylene diisocyanate and dibutyltin dilaurate was added, and stirred for 10 min. The liquid mixture was rapidly disposed between two glass plates separated by a silicone rubber spacer, and placed in an oven at 80° C. for 48 h, subsequently dried under vacuum at 80° C. overnight, and finally irradiated in an ultraviolet oven under 4 UV lamps with a wavelength of 365 nm and a power of 5 W for 15 h, so that the polycaprolactone shape memory material was prepared.

### Example 9

The method of preparing the polycaprolactone shape memory material comprised the following steps:

Step 1: 5.8×10⁻⁵ mol of the polyethylene glycol diamine with a weight average molecular weight of 35 kDa was weighed, and added to a saturated aqueous solution of α-cyclodextrin (7.25 g/50 mL, double distilled H₂O). The mixture was stirred at room temperature for 24 h to obtain a white precipitate, which was then lyophilized in a lyophilizer for 48 h to obtain a clathrate.

2.7×10⁻³ mol of N-benzyloxycarbonyl-L-tyrosine (Z-L-Tyr), BOP reagent, 1-hydroxybenzotriazole (HOBt) and N,N-Diisopropylethylamine (DIEA) were dissolved in a small amount of N,N-Dimethylformamide (DMF) in sequence, the clathrate was added to the solution, the suspension was subjected to the amidation reaction at 20° C. for 30 h, the suspension was put in excessive ether to precipitate the initial product, and the precipitate was collected by centrifugation at 2,000 rpm for 20 min at room temperature, the precipitate was then continuously washed with a large amount of acetone, methanol, and water respectively and stirred for three times, the precipitate was lyophilized to obtain a polyrotaxane (PR).

An appropriate amount of polyrotaxane was weighed and dissolved in 50 mL of NaOH solution with a concentration of 1 mol/L, an appropriate amount of epoxy propane was dropwise added under the ice bath conditions, and the mixture was stirred overnight. The reaction temperature was gradually raised to room temperature as the ice in the solution melted. The samples were dialyzed and purified with deionized water for one week and then lyophilized. The lyophilized sample was poured into 100 mL of dichloromethane and stirred overnight to filter out free polyethylene glycol decomposed and generated during the hydroxypropylation process, subsequently washed with a large amount of acetone, and the precipitate was centrifugated and collected then dried under vacuum at 60° C. to obtain hydroxypropylated polyrotaxane (HP-PR).

Step 2: the HP-PR and purified ϵ-caprolactone (ϵ-CL) in a molar ratio (number of active hydroxyl on HP-PR: ϵ-CL=1:600) were fed into a dry and silanized round-bottomed flask, 1 wt. % of stannous octoate was added in terms of the total mass, the high-purity nitrogen gas was introduced for replacing the air in said round-bottomed flask, the mixture was reacted at 130° C. for 48 h. The initial product was then dissolved with a small amount of tetrahydrofuran, precipitated in an excessive amount of n-hexane three times, and the precipitate was vacuum-dried at 60° C. for 48 h to obtain a polycaprolactone grafted polyrotaxane copolymer (PCL-g-PR).

Step 3: 0.5 molar equivalent of 4-nitrocinnamate of the number of active hydroxyl groups of HP-PR was weighed, and dissolved in 25 mL of DMF at 50° C., the DMF solution of PCL-g-PR was added to the DMF solution of 4-nitrocinnamic acid and stirred for 30 min. 1 molar equivalent of N,N-diisopropyl carbodiimide and 0.5 molar equivalent of 4-dimethylaminopyridine were subsequently added, the mixture was reacted at 40° C. for 25 h. The primary product was precipitated in excessive diethyl ether, and centrifuged to collect a solid, the solid product was dissolved in a small amount of toluene, then precipitated in diethyl ether three times, the precipitate was subjected to vacuum drying at 60° C. overnight to obtain a polymer network precursor, wherein the end groups were partially modified into the cinnamate groups.

Step 4: the polymer network precursor was dissolved in N,N-dimethylformamide at 80° C., a proper amount of n-butyl acetate solution of hexamethylene diisocyanate and dibutyltin dilaurate was added, and stirred for 10 min. The liquid mixture was rapidly disposed between two glass plates separated by a silicone rubber spacer, and placed in an oven at 80° C. for 48 h, subsequently dried under vacuum at 80° C. overnight, and finally irradiated in an ultraviolet oven under 4 UV lamps with a wavelength of 380 nm and a power of 5 W for 12 h, so that the polycaprolactone shape memory material was prepared.

### Comparative Example 1

A thermally crosslinked polycaprolactone shape memory plate material was prepared from the following components in parts by weight: 90 parts of polycaprolactone, 5 parts of a crosslinking agent benzoyl peroxide, 80 parts of solvent dichloromethane and 1 part of a release agent.

The method of preparing the thermally crosslinked polycaprolactone shape memory plate material comprised the following preparation steps:
Step 1: polycaprolactone, cross-linking agent benzoyl peroxide, and solvent dichloromethane were placed in a round-bottom flask for performing the solution blending, the mixture was subjected to an ultrasonic treatment for 30 min, and transferred to a mechanical stirrer for stirring for 1 h, the mixture was obtained;
Step 2: the obtained mixture was used for volatilizing the solvent for 1-2 h at room temperature, and subjected to vacuum drying at 50-70° C. for 24 h to obtain a PCL/BPO solid mixture;
Step 3: the solid mixture obtained in step (2) was placed in a customized iron mold, and sprayed with a mold release agent, a flat vulcanizing machine was used for causing the peroxide to initiate the polycaprolactone to be subject to a thermally crosslinking treatment at the temperature of 140-160° C. for 5-15 min under the maximum pressure of 10 MPa, the thermally crosslinked polycaprolactone shape memory plate material was obtained.

The products obtained in Examples 1-9 and Comparative Example 1 were subjected to measurements of gel content, shape recovery velocity, shape recovery rate, elongation at break, and tensile strength, the results were shown in Table 1.

TABLE 1
Comparison of the performance parameters of
the Examples and the Comparative Example

| | | Shape | The shape | | |
|---|---|---|---|---|---|
| | | recovery | recovery | | |
| | Gel | velocity | rate | Elonga- | Tensile |
| | content/ | from 100% | from 100% | tion at | strength/ |
| Samples | wt % | strain/s | strain/% | break/% | MPa |
| Example 1 | 77.6 | 2 | 99.6 | 900 | 26 |
| Example 2 | 66.2 | 2 | 98.3 | 965 | 41 |
| Example 3 | 37.3 | 3 | 95.2 | 1130 | 42 |
| Example 4 | 71.7 | 2 | 99.4 | 950 | 29 |
| Example 5 | 64.0 | 2 | 99.2 | 992 | 40 |
| Example 6 | 42.3 | 3 | 97.7 | 1204 | 43 |
| Example 7 | 62.1 | 3 | 98.9 | 960 | 30 |
| Example 8 | 53.7 | 3 | 98.0 | 973 | 42 |
| Example 9 | 44.4 | 4 | 97.9 | 1320 | 44 |
| Comparative | 60.9 | 11 | 91.4 | 658 | 43 |
| Example 1 | | | | | |

As can be seen from the results in Table 1, the polycaprolactone shape memory materials of Examples 1-9 prepared with the method of the present disclosure have a faster shape recovery velocity and a higher shape recovery rate than the products prepared by the Comparative Example 1, and can recover to 95% or more of the original shape within 5 s. In addition, when the elongation at break and the tensile strength of the product obtained in Examples 1-9 are compared with the measurement result of Comparative Example 1, the elongation at break of the product obtained in Examples 1-9 is improved, for instance, the elongation at break of the product prepared in Example 9 is improved by one time, which demonstrates that the toughness of shape memory material can be improved.

The above content describes in detail the preferred embodiments of the present disclosure, but the present disclosure is not limited thereto. A variety of simple modifications can be made in regard to the technical solutions of the present disclosure within the scope of the technical concept of the present disclosure, including a combination of individual technical features in any other suitable manner, such simple modifications and combinations thereof shall also be regarded as the content disclosed by the present disclosure, each of them falls into the protection scope of the present disclosure.

1. A polycaprolactone shape memory material comprising a plurality of modified polyrotaxane macromolecular chains, and a plurality of composite macromolecular chains connected to different modified polyrotaxane macromolecular chains, wherein each of the composite macromolecular chains comprises at least two segments of polycaprolactone macromolecular chains, a reversible linking group between different polycaprolactone macromolecular chains, and a linking modification group for linking cyclodextrin-derived cyclic structures comprised in the polycaprolactone macromolecular chains and the modified polyrotaxane macromolecular chains, wherein the reversible linking group is a photo-reversible linking group or a thermally reversible linking group.

2-15. (canceled)

16. The polycaprolactone shape memory material of claim 1, wherein the photo-reversible linking group is derived from a compound having a photo-reversible group;
and/or, the thermally reversible linking group is derived from diisocyanate.

17. The polycaprolactone shape memory material of claim 16, wherein the compound is selected from nitrocinnamate compounds and/or 4-((4-methyl-2-oxo-2H-chromene-7-yl)oxy)butyric acid;
and/or, the diisocyanate is preferably at least one selected from the group consisting of hexamethylene diisocyanate, toluene diisocyanate, isophorone diisocyanate, and lysine diisocyanate.

18. The polycaprolactone shape memory material of claim 1 wherein the linking modification group is derived from a compound for hydroxypropylation.

19. The polycaprolactone shape memory material of claim 18, wherein the linking modification group is a group represented by the structural formula —CH₂—CH(CH₃)—O—.

20. The polycaprolactone shape memory material of claim 1, wherein the total amount of the polycaprolactone molecular chains is from 80 wt % to 100 wt %, based on the total amount of the modified polyrotaxane macromolecular chains;
and/or, the polycaprolactone macromolecular chains have a weight average molecular weight within the range from 5,000 kDa to 100,0000 kDa;
and/or, the modified polyrotaxane macromolecular chains have a weight average molecular weight from 10 kDa to 100 kDa.

21. The polycaprolactone shape memory material of claim 1, wherein the polycaprolactone shape memory material has an elongation at break of more than 900%, the polycaprolactone shape memory material has a gel content within the range from 37 wt % to 78 wt %, and the time for the polycaprolactone shape memory material to recover from 100% strain to an original shape is not more than 5 s.

22. A composition for preparing the polycaprolactone shape memory material of claim 1 comprising a polyrotaxane initiator, an end group modifier, ϵ-caprolactone, a catalyst, and a cross-linking agent; wherein the end group modifier is selected from nitrocinnamate compounds and/or 4-((4-methyl-2-oxo-2H-chromene-7-yl)oxy)butyric acid.

23. The composition of claim 22, wherein the polyrotaxane initiator has a weight average molecular weight from 10 kDa to 100 kDa;
and/or, the catalyst is at least one selected from the group consisting of stannous octoate, lithium diisopropylamide, scandium trifluoromethane sulfonate, and phosphazene base;
and/or, the crosslinking agent is selected from diisocyanate.

24. The composition of claim 23, wherein the crosslinking agent is at least one selected from the group consisting of hexamethylene diisocyanate, toluene diisocyanate, isophorone diisocyanate, and lysine diisocyanate.

25. The composition of claim 22, wherein the composition comprises the polyrotaxane initiator within a range from 0.01 wt % to 0.1 wt %, ϵ-caprolactone within a range from 99 wt % to 99.99 wt %, the catalyst within a range from 0.5 wt % to 2 wt %, the end group modifier within a range from 0.02 wt % to 0.05 wt %, and the crosslinking agent within a range from 0.1 wt % to 1 wt %, based on the total weight of the composition.

26. A method for preparing a polycaprolactone shape memory material comprising the following steps:
(1) subjecting the polyrotaxane to a hydroxypropylation to obtain hydroxypropylated polyrotaxane;
(2) carrying out a ring-opening polymerization on the hydroxypropylated polyrotaxane and ϵ-caprolactone in the presence of a catalyst, to obtain a polycaprolactone grafted polyrotaxane copolymer;
(3) subjecting the polycaprolactone grafted polyrotaxane copolymer and photo-reversible groups of an end group modifier to a modification reaction to obtain a polymer network precursor, wherein the end group part of the polymer network precursor is modified into the photo-reversible group;
(4) promoting the reaction of the photo-reversible group to cross-link the polymer network precursor in the presence of a cross-linking agent and the action of heating and ultraviolet light, to prepare the polycaprolactone shape memory material.

27. The method of claim 26, wherein the catalyst in step (2) is at least one selected from the group consisting of stannous octoate, lithium diisopropylamide, scandium trifluoromethane sulfonate, and phosphazene base;
and/or, the used amount of the catalyst is from 0.5 wt % to 2 wt %, based on the total mass of the hydroxypropylated polyrotaxane and ϵ-caprolactone;
and/or, the mole ratio of the hydroxypropylated polyrotaxane in terms of the number of active hydroxyls contained therein to ϵ-caprolactone is 1:(50-600);
and/or, the ring-opening polymerization temperature is within the range from 100° C. to 140° C., and the ring-opening polymerization time is within the range from 40 h to 50 h;
and/or, the process of ring-opening polymerization comprises: subjecting the mixture of hydroxypropylated polyrotaxane, ϵ-caprolactone and the catalyst to a polymerization reaction under the protection of nitrogen gas; dissolving the obtained primary product with tetrahydrofuran, then carrying out precipitation in n-hexane for many times, subsequently drying the obtained solid-phase precipitate to prepare the polycaprolactone grafted polyrotaxane copolymer.

28. The method of claim 26, wherein the molar ratio of the end group modifier to the polycaprolactone grafted polyrotaxane copolymer in step (3) is (100-400):1;
and/or, the end group modifier is selected from compounds having a photo-reversible group;
and/or, the temperature of the end group modification reaction is within the range from 40° C. to 60° C., and the time of the end group modification reaction is within the range from 15 h to 25 h;
and/or, the process of the end group modification reaction comprises: mixing the end group modifier and the polycaprolactone grafted polyrotaxane copolymer respectively with a solution prepared with a first organic solvent, adding a water absorbent-I and an esterification catalyst into the obtained mixed solution, and then carrying out the end group modification reaction; subjecting the obtained initial product to precipitation for many times, and drying the obtained solid precipitate to obtain the polymer network precursor.

29. The method of claim 28, wherein the the end group modifier is selected from nitrocinnamate compounds and/or 4-((4-methyl-2-oxo-2H-chromene-7-yl)oxy)butyric acid.

30. The method of claim 28, wherein the polymer network precursor has a plurality of slidable polycaprolactone molecular chains, and a part of the chain ends of the polycaprolactone molecular chains contain a photo-reversible group derived from the end group modifier.

31. The method of claim 26, wherein the crosslinking agent in step (4) is selected from diisocyanates;
and/or, the used amount of the crosslinking agent is from 0.1 wt % to 1 wt % of the polymer network precursor;
and/or, the heating temperature is within the range from 70° C. to 90° C., and the heating time is within the range from 45 h to 60 h;
and/or, the wavelength of the ultraviolet light is within the range from 250 nm to 380 nm;
and/or, the crosslinking process comprises: dissolving the polymer network precursor in a second organic solvent, then adding a butyl acetate solution of the crosslinking agent and the crosslinking catalyst to obtain a liquid mixture; heating and drying the liquid mixture, then irradiating under the ultraviolet light to obtain the polycaprolactone shape memory material.

32. The method of claim 31, wherein the crosslinking agent in step (4) is selected from at least one selected from the group consisting of hexamethylene diisocyanate, toluene diisocyanate, isophorone diisocyanate, and lysine diisocyanate.

33. The method of claim 26, wherein the polyrotaxane is prepared with the following process: reacting α-cyclodextrin with polyethylene glycol diamine in the presence of a large steric hindrance compound.

34. The method of claim 33, wherein the large steric hindrance compound is at least one selected from the group consisting of N-benzyloxycarbonyl-L-tyrosine, 1-adamantane acetic acid, fluorescein isothiocyanate, and L-phenylalanine;
and/or, the polyethylene glycol diamine has a weight average molecular weight from 5 kDa to 40 kDa;
and/or, the molar ratio of a-cyclodextrin to the polyethylene glycol diamine is (50-100):1;
and/or, the molar ratio of the large steric hindrance compound to the polyethylene glycol diamine is (2-10):1;
and/or, the reaction process comprises the following steps:
(i) adding the polyethylene glycol diamine into a saturated aqueous solution of α-cyclodextrin, stirring at the temperature from 20° C. to 35° C. for a time from 20 h to 40 h, and drying the obtained white precipitate to obtain a clathrate compound;
(ii) dissolving the large steric hindrance compound, the amidation catalyst, and the water absorbent-II in a third organic solvent to prepare a solution, then adding the clathrate compound into the solution, subjecting the obtained suspension to an amidation reaction and then performing precipitation, and washing and drying the obtained solid-phase precipitate to prepare the polyrotaxane;
and/or, the polyrotaxane has a weight average molecular weight within the range from 10 kDa to 100 kDa.
